(19) United States
(12) Patent Application Publication
(10) Pub. No.: US 2003/0070559 A1
(43) Pub. Date: Apr. 17, 2003

(54) Vegetable and related food products steamer cooker

(76) Inventor: Robert J. Victor, Columbia, MO (US)

Correspondence Address: Paul M. Denk, 763 South New Ballas Road, St. Louis, MO, 63141, US

(21) Appl. No.: 10/270,833

(22) Filed: Oct. 14, 2002

Related U.S. Application Data
(60) Provisional application No. 60/329,270, filed on Oct. 15, 2001.

(51) Int. Cl. A47J 37/12

(52) U.S. Cl. 99/417; 99/416

(57) ABSTRACT

A steaming cooker for use for heating and cooking of vegetables, such as corn, potatoes, and the like, includes a container, with a removable or pivotal opening lid, having a rack therein, incorporating a surface having a series of provided apertures therethrough, and into which a capacity of water may be applied, within its container, stabilized below the surface of the rack, so that any vegetables placed upon the rack, when the water therein is heated and boiled, during usage of the steaming cooker, provides a highly moisturized cooking environment of any food product in preparation for consumption.

### BACKGROUND OF THE INVENTION

Variety of pressure and related cookers are readily available in the art, wherein steam may be generated, normally under cooking conditions, in order to accelerate the heating and cooking of food product for consumption. The art has long known about and as used the means for cooking identified as the double boiler, wherein the bottom pan would hold a quantity of water, which would be boiled, while the top pan, that interfits therein, contains the food product to be warmed or cooked. In that type of construction, though, generally the steam would never attain access directly to the food product, but simply provided a more controlled heat for heating of the food product contained in the upper pot.

The current invention, differing from the principle of these prior inventions, utilizes a cooker of some size that has the water applied directly into its bottom location, while a holder for the food product, to be heated or cooked, is directly applied into the water, so as to expose the food to direct contact and access with the generated steam, for cooking, and substantial moisturizing purposes.

### SUMMARY OF THE INVENTION

This invention relates generally to cooking, and more specifically provides a structure and means for directly steaming vegetables and related food products for cooking, through direct access and contact with the generated steam within its cooker.

This invention contemplates the information of a cooker, generally of some magnitude, and which is provided for cooking, in bulk, one, or more, or a variety of food products, such as corn, potatoes, and even other vegetables, through direct access to the steam generated within the cooking container. This invention generally embodies a large size container, having some length, width, depth, and into which an elevated tray may locate, with the tray having a series of apertures provided therein, and which may function effectively to support and hold into position the various vegetables or other food products to be cooked, such as standing corn, potatoes, and related foods. In the preferred embodiment, the tray is formed having approximately eighty four apertures, into which eighty four ears of corn, or potatoes, may be applied, stood on end, exposed directly to the generation of steam, by heating, therebelow, within the cooking container, to provide for a highly moisturized yet cooked food product, for consumption.

Since this cooker has some size, a substantially sized lid may be applied thereon, in order to provide some degree of closure, not necessarily in the form of a pressure cooker, with a lid preferably having in the preferred embodiment a hinge means provided at approximately its center, so that the lid may be folded back, to either side, and allow direct access into a segment of the cooking food, either for placement, replacement, shifting, or removal, especially when cooked, and ready for serving. At the same time, this reduces the ability for the steam to escape.

A feature of this invention is that it is made to some magnitude, to provide for the cooking of a large plurality of such food products, and therefore have special advantages for use when applied for cooking at any type of a gathering, such as at a fair, large family gathering, church or club functions, and the like, and thereby steam cook a large number of food products, simultaneously, in order to feed the numerous persons in attendance, simultaneously.

It is, therefore, the principle object of this invention to provide a cooker that can cook a large amount of food products simultaneously, to provide for mass feeding of attendees.

Still another object of this invention to provide a uniquely designed cooker, that functions as a steamer in its lower regions, having a supporting tray positioned above the level of the contained boiling water, and designed for holding a plurality of food products, simultaneously, for steam cooking in preparation for serving.

Another object of this invention to provide a uniquely styled lid or hood for the cooking container, and which is hinged to provide for its partial opening, to obtain isolated access to various parts of the cooker, during its usage.

Yet another object of this invention, and to provide a highly desirable attribute, is to furnish a means for cooking that effectively retains moisture in the food product during its cooking by providing direct access to the generated steam, through boiling, within the confines of the cooking container.

Another object is to provide a cooking container that will conveniently fit over the standard sized one or more gas grills, to furnish cooking at remote locations, such as at the fair grounds, the park, in the back yard, and other locations where electricity or natural gas service may not otherwise be available.

Another object of this invention is to provide a steaming cooker, which while being fabricated of some size, is relatively light weight, and has convenient portability during its transit.

These and other objects may come more apparent to those skilled in the art upon reviewing the invention as described herein, and when undertaking a view of its drawings.

### BRIEF DESCRIPTIONS OF THE DRAWINGS

In referring to the drawings, FIG. 1 provides an isometric view of the vegetable and related food products steaming cooker of this invention;

FIG. 2 is an exploded view of the steaming cooker with its various components elevated therefrom;

FIG. 3 is a side view of the cooker, showing the location of its supporting tray, shown in hidden line, therein;

FIG. 4 is a top plan view thereof;

FIG. 5 is an end view thereof; and

FIG. 6 is a view looking into the cooker with its lid removed, and showing the apertured food products supporting shelf.

### DESCRIPTION OF THE PREFERRED EMBODIMENT

In referring to the drawings, in particular FIG. 1, therein is shown the steaming cooker 1 of this invention. It is structured as a container 2 of some size, having a lid 3 removably provided thereon. Handles 4 are provided at one or both ends of the container, and a drain plug 5 is furnished, at a lower level of the container, and which when threadedly removed or otherwise opened, allows for drain out of its contained water, such as after a performance of a cooking process.

The lid 3 is disclosed as being bifurcated, formed of two portions 6 and 7, with each portion having a handle 8 or 9, provided to facilitate the opening of at least half of the lid, when it is desired to obtain access into a segment of the cooking container, as previously reviewed.

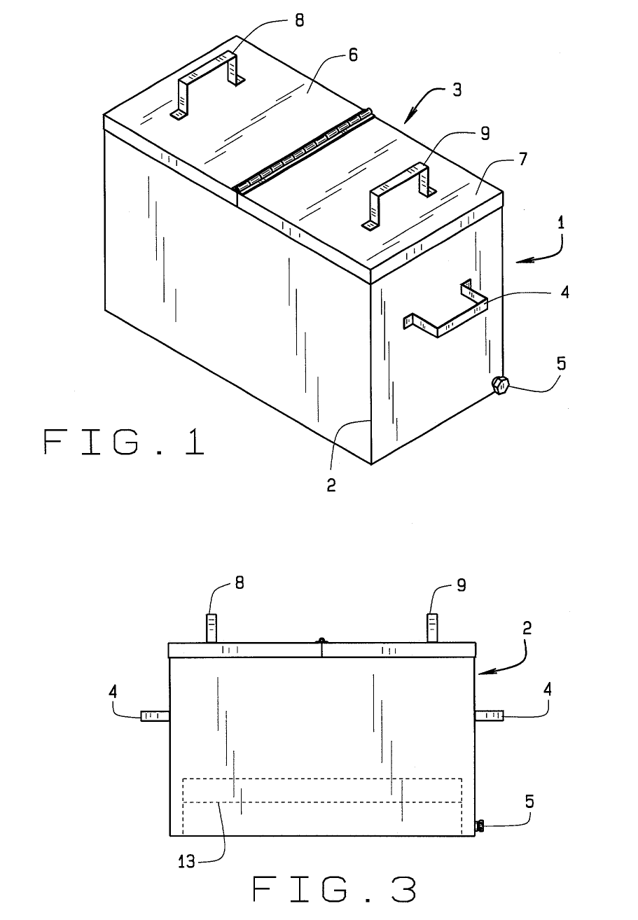

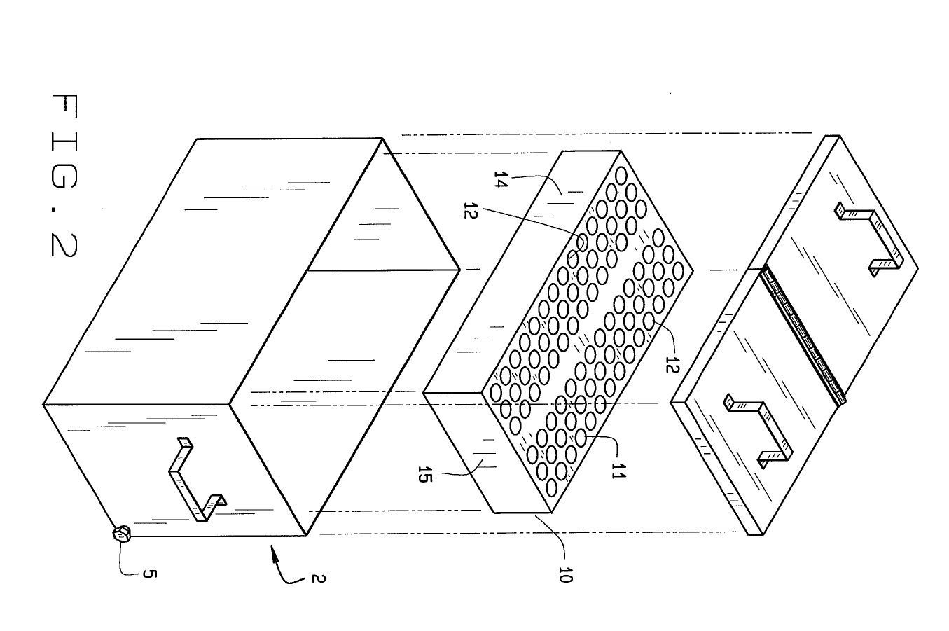

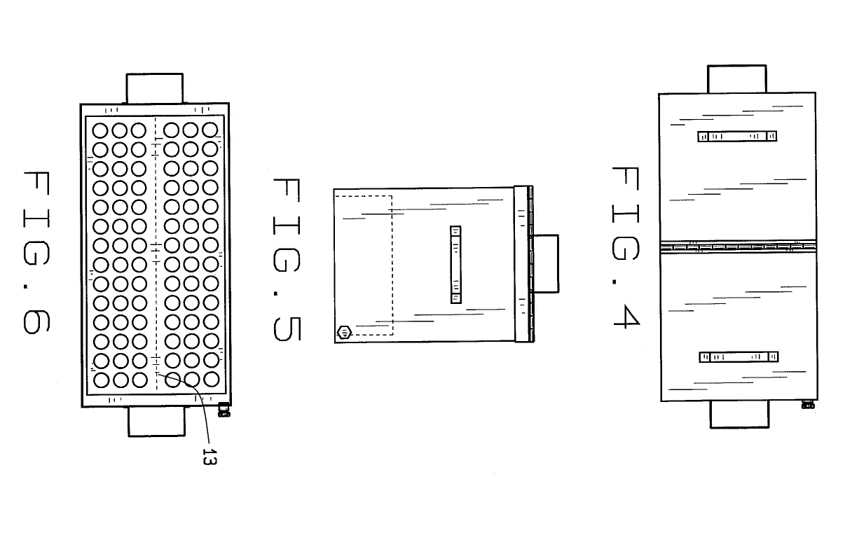

As can be seen in FIG. 2, the container 2 for the cooker has significant capacity, and in the preferred embodiment, the container may be approximately 31 to 32 inches long, 15 to 16 inches wide, and approximately 26 inches high, in its structure. Obviously, other dimensions may be provided, but those provided therein are explained for the preferred embodiment, to give some relative size to the structure of this cooking container. Its plug 5 may be threadedly engaged therein, which when removed, provides a drain or vent, from which the water previously supplied into the cooking container, may be discharged.

As can also be seen in FIG. 2, a designed tray 10 is provided. The tray has dimensions slightly less than the interior dimensions of the container 2, so that the tray may be easily and conveniently inserted therein, without any obstruction. This tray, shelf, or rack, may be approximately 6 inches high, so as to provide some elevation upwardly from the bottom of the container 2, and to allow for its upper surface 11 to normally be arranged above the high water level of the water added therein, since the desired form of cooking of the food product is through the generated steam, and not from direct contact with the boiling water itself, as can be understood. As noted, there are a series of apertures 12 provided within and through the upper surface 11 of the rack, and the apertures are designed for accommodating various sized food products therein, so as to, preferably, stand them erect, in preparation for performance of a cooking procedure. For example, one of the preferred uses for this particular cooking container is for use for steaming corn, until cooked. Or, potatoes may be stood on end, within the various apertures, in preparation for exposure to the cooking procedure.

To add further reinforcement to the perforated or aperture surface, for the rack, there may be provided along its length, a reinforcing wall, as at 13, which may extend the same height as the side walls 14 and the end walls 15 for the shown rack, or may be only of partial height, as noted in FIG. 3, but significant enough to add structural rigidity to the formed rack, during its usage, since it may support, as previously explained, in the preferred embodiment, as many as eighty four various types of vegetables, in preparation and during cooking. The reinforcing wall connects to the end walls, or to the side walls, if it extends transversely.

In usage, such as for application in steam cooking of potatoes, a plurality of such potatoes will be cleaned, washed, and then stood on end in the cooker, supported within the apertures of the surface of the rack, readied for exposure to a cooking process. Or, ears of corn may be partially shucked, with the husk and its silk at least partially pulled free, and then stood, at their bottom end, in the apertures of the rack, vertically arranged, and readied for steam cooking. Then, or previous thereto, a supply of water, perhaps three to five inches of the same, is deposited into the bottom of the container 2, in preparation for cooking. At this time, the steaming cooker will have been set upon the burner, whether it be a burner or flames generated from natural gas, or perhaps from bottled gas, or perhaps even through wood burning, to generate sufficient heat to boil the water within the cooker, during performance of the cooking process. Depending upon the type of vegetable being cooked, gauges the amount of time necessary to achieve a cooking process. Normally, steaming corn from twenty to thirty minutes has been found sufficient to adequately cook it and prepare it for consumption. Since it is cooked within a moisturized environment, the corn remains substantially juicy, loses very little of its natural juice, has excellent flavor characteristics for immediate consumption. Potatoes, preferably remaining within their skins, likewise may be set up in the cooker, upon its rack, in a manner similar to that as the emplacement of corn, and then steam cooked, after the water attains boiling, for approximately forty minutes, to provide a very moisturized but yet cooked potato that is ready for consumption, as desired.

In addition, since this steaming cooker can be made to almost any size, depending upon the size capacity of the burners employed, a large plurality of such vegetables may be cooked, simultaneously, for serving. Or, it is just as likely that the steam cooker of this invention could be made to smaller dimensions, yet having a rack contained therein, and which may conveniently support two, four, six or eight items of vegetables, for cooking domestically, in preparation for dinner, or other meal, as in the home. These are examples as to the usage and application for the steaming cooker of this invention.

After the steaming cooker of this invention has been employed, as for example, throughout the day for cooking vegetables, corn, potatoes, and the like, for a large capacity crowd, such as at the fair grounds, craft fairs, family gatherings, or even at the home, and is desired to dismantle the cooker for cleaning and transit, and storage, all one need do is to remove the drain plug, or open its spigot, if such a drain is provided therein, to allow for drainage of the cooking water, that had been previously boiled to generate the steam required for cooking of such food product, during usage of the steaming cooker of this invention.

Variations or modifications to the subject matter of this invention may occur to those skilled in the art upon reviewing the disclosure as provided herein. Such variations, if within the spirit of this development, are intended to be encompassed within the scope of the invention as explained. The description of the preferred embodiment, and its various dimensions, as described herein, and as depicted in the drawings, are set forth for illustrative purposes only.

1. A vegetable and related food products steamer cooker including a container, said container being formed having side walls, end walls, and a bottom wall, a drain being provided within the lower portion of one of said walls, a lid for the container, said lid being bifurcated and formed of two portions, the contiguous edges of said two portions being hinged together, a handle provided upon each lid portion to provide for its pivoted opening, and said lid being provided for furnishing closure to the container during usage; a tray provided within the container, said tray disposed for resting upon the bottom wall of said container, said tray having an upper surface normally arranged above the bottom wall of said container, and said surface provided for normally being arranged above the high water level of any water added to the container during a steamer cooker operation, the upper surface of said rack being perforated, so that any vegetables or related food products put upon the perforated upper surface of the rack will be steam cooked during heating of the water provided within the container during operation.

2. The steamer cooker of claim 1 wherein said rack having side walls and end walls, to provide for the upward displacement of the perforated surface of said rack, and to provide for its displacement above any high water level maintained within the container during a cooking operation.

3. The steamer cooker of claim 2 and including a reinforcement extending along the length of the rack, below the perforated surface, to add to the strength of the rack during usage.

4. The steamer cooker of claim 3 wherein the reinforcement extends and connects between the two end walls of the rack.

5. The steamer cooker of claim 3 wherein the reinforcement extends between the side walls of the formed rack.

6. In the method for providing cooking of any vegetables or related food products within the container as described in claim 1, including providing a quantity of water within the container, below the rack, and maintaining said water level below the perforated surface of said rack during usage, applying vegetables or related food products to the perforated surface of the rack, heating the water contained within the container through the application of heat to the bottom of said container during usage, whereby steam generated from the boiling water cooks the vegetable or related food products during the operation and usage of the steamer cooker.

7. The steamer cooker of claim 6 and including opening said drain to dispose of the boiling water after completion of cooking operations.
